(19) United States
(12) Patent Application Publication
(10) Pub. No.: US 2006/0290665 A1
(43) Pub. Date: Dec. 28, 2006

(54) Slide pad notebook pointing device with sealed spring system

(76) Inventors: Farid Matta, Los Altos, CA (US); Jonah Harley, Mountain View, CA (US); Dale Schroeder, Scotts Valley, CA (US); Calvin B. Ward, Castro Valley, CA (US)

Correspondence Address: AVAGO TECHNOLOGIES, LTD., P.O. BOX 1920, DENVER, CO, 80201-1920, US

(21) Appl. No.: 11/165,904

(22) Filed: Jun. 24, 2005

(51) Int. Cl. G09G 5/08

(52) U.S. Cl. 345/157

(57) ABSTRACT

A pointing device having top and bottom pucks that move on a stage is disclosed. The top puck moves over the top surface of the stage in response to a lateral force applied thereto. The top and bottom pucks are magnetically coupled such that the two pucks maintain a predetermined relative position with respect to one another. A position sensor generates a signal indicative of the location of the bottom puck. The pointing device can also include a pressure signal generator that generates a user present signal if the top puck is subjected to a force greater than a first force level. The determined pressure can also be used to simulate a button being pushed. Exemplary pressure signal generators utilize strain gauges, variable capacitors in the top puck, and circuits for detecting the vertical distance between the top and bottom pucks when the top puck includes a deformable member.

### BACKGROUND OF THE INVENTION

To simplify the following discussion, the present invention will be explained in terms of a pointing device for use on a computer; however, the present invention may be utilized with a wide range of data processing systems including hand held computers, cell phones, video games, and the like. Modem computer operating systems and graphics programs require a pointing device for controlling the position of a cursor on the computer display. For desktop PCs, the most successful pointing device is the “mouse”. A mouse is a hand held object that is moved over a flat surface near the keyboard to control the motion of a cursor on the computer display. The direction and distance over which the mouse is moved determines the direction and distance the cursor moves on the display. A conventional mouse provides a rigid object that a user can move with great precision. For a desktop computer, the mouse provides a satisfactory solution to the pointing problem. On the occasion when the workspace is not large enough to provide a path over which the mouse can move and accommodate the desired cursor movement on the display, the user simply picks up the mouse and recenters the mouse in the workspace. Hence, the mouse can provide an almost limitless range of motion.

While the mouse has provided a satisfactory solution to the pointing device problem in the desktop PC market, a similarly successful device is not available for portable and hand-held computers. These computers are often used in environments that lack a sufficiently large flat surface near the keyboard over which a mouse can be moved. Hence, some other form of pointing device is needed when these computers are used in such environments.

A pointing device for use in these environments must solve the problem of moving a cursor quickly and accurately. In addition, the device must operate in an intuitive fashion that a novice user can comprehend without extensive instruction. Further, the pointing device must operate in a limited workspace and fit within the form factor of the computer or hand held device. Finally, the usual constraints of low cost, low power consumption and high reliability must also be met.

In previously filed U.S. patent application Ser. No. 10/723,957, which is hereby incorporated by reference, a pointing device that meets these requirements is described. The pointing device utilizes a puck that moves in a defined field of motion when a user applies pressure to the puck via the user's finger. When the user releases the puck, a set of springs returns the puck to its centered position within the field of motion. The position of the puck is determined by electrodes in the device and is used to position a cursor on the display screen. Software on the attached device translates the motion of the puck during the time the user's finger is pressing on the puck into the appropriate cursor motion on the device's display. For applications where the puck field of motion can map to the full cursor field of motion, the cursor and puck can be permanently coupled, both returning to the center of their respective fields when the puck is released. When the cursor field of motion exceeds the puck field of motion, as is the case on most laptop computers, or where re-centering of the cursor is otherwise undesirable, some mechanism is necessary to decouple the cursor motion from the puck motion during puck re-centering. In these cases, the presence of the user finger is also sensed, so when the user releases the puck, the coupling between the puck and the cursor position is broken by the software, and hence, the cursor does not move while the puck is being recentered.

While the device taught in the above-described patent application provides significant advantages over the dominant prior art solutions to the pointing device problem in the laptop marketplace, there are a number of areas in which improvements would be useful. In particular, it would also be advantageous to provide embodiments in which the springs are not visible and in which the spring mechanism is covered to prevent debris from collecting on or around the springs.

### SUMMARY OF THE INVENTION

The present invention includes a pointing device having top and bottom pucks that move on a stage. The stage includes top and bottom surfaces. The top puck moves over the top surface in response to a lateral force applied thereto. The top puck includes a first magnetic coupling member. The bottom puck moves under the bottom surface and includes a second magnetic coupling member. The first and second magnetic coupling members couple the pucks such that the bottom puck moves in response to a change in location of the top puck to maintain a predetermined relative location with respect to the top puck. A position sensor generates a signal indicative of the location of the bottom puck. In one embodiment, the pointing device includes a spring system for returning the bottom puck to a predetermined location when the lateral force is not applied to the top puck. One of the first and second magnetic coupling members includes a magnet. The other magnetic coupling member can include a magnet or ferromagnetic material The bottom puck can be enclosed in a sealed cavity. In one embodiment, the pointing device also includes a pressure signal generator that generates a user present signal if the top puck is subjected to a force greater than a first force level. In one embodiment, the pressure signal generator generates a button actuated signal if the top puck is subjected to a force greater than a second force level, the second force level is greater than the first force level. Exemplary pressure signal generators utilize strain gauges, variable capacitors in the top puck, and circuits for detecting the vertical distance between the top and bottom pucks when the top puck includes a deformable member that changes the vertical distance in response to force being applied to the top puck. In one embodiment, the position sensor includes a bottom puck electrode on the bottom puck, a plurality of position electrodes on the stage, and a circuit for measuring a capacitance value between the bottom puck and each of the position electrodes. In one embodiment, the position sensor includes a light source and an imaging sensor that moves with the bottom puck.

### BRIEF DESCRIPTION OF THE DRAWINGS

FIG. 1A is a top view of pointing device 10.

FIG. 1B is a cross-sectional view of pointing device 10 through line 1B-1B shown in FIG. 1A.

FIG. 2 illustrates a data processing system that utilizes a pointer according to the present invention.

FIG. 3 is a top view of a portion of surface 12 shown in FIG. 1 over which the puck moves in one embodiment of the present invention.

FIG. 4 is a schematic drawing of an equivalent circuit for electrodes 51-55.

FIG. 5 is a cross-sectional view of a puck-based pointing system with a hidden spring and sensing system.

FIG. 6 is a cross-sectional view through pointing device 70.

FIG. 7 is an enlarged cross-sectional view of bottom puck 80 shown in FIG. 6.

FIG. 8 is a cross-sectional view of a pointing device according to another embodiment of the present invention.

FIG. 9 is a cross-sectional view through top puck 101 and bottom puck 111.

FIG. 10 is a schematic drawing of a circuit that can be used to measure the capacitance of capacitor 109.

FIG. 11 illustrates a pointing device according to another embodiment of the present invention.

FIG. 12 illustrates another embodiment of a pointing device according to the present invention.

### DETAILED DESCRIPTION OF THE PREFERRED EMBODIMENTS OF THE INVENTION

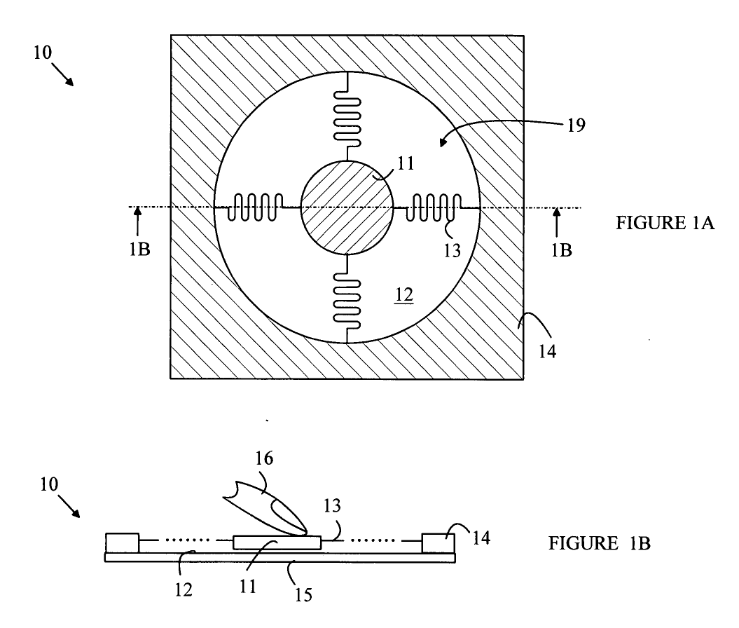

The manner in which the present invention provides its advantages can be more easily understood with reference to FIGS. 1A and 1B, which illustrate a pointing device 10 according to one embodiment of the invention taught in the above-described patent application. FIG. 1A is a top view of pointing device 10, and FIG. 1B is a cross-sectional view of pointing device 10 through line 1B-1B shown in FIG. 1A. Pointing device 10 includes a puck 11 that moves over a surface 12 of a substrate 15 within a puck field of motion 19 in response to a lateral force applied to puck 11. The force is typically applied to puck 11 by a user's finger. Puck 11 optionally includes a pressure sensing mechanism that measures the vertical pressure applied to puck 11. In addition, pointing device 10 includes a sensing mechanism for determining the position of puck 11 on surface 12.

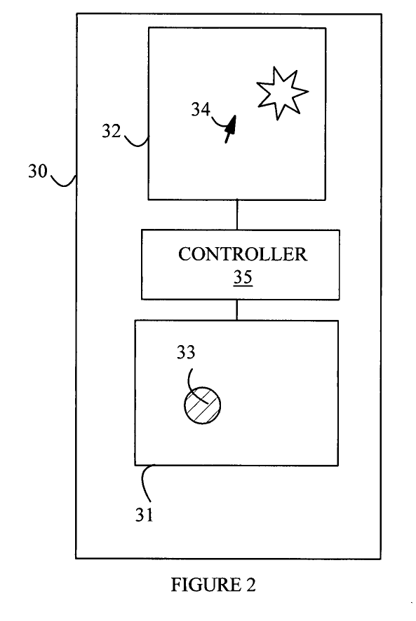

A pointing device is typically included in a data processing system to control the cursor on the screen of a display associated with that data processing system. Refer additionally to FIG. 2, which illustrates a data processing system that utilizes a pointer 31 according to the present invention. Data processing system 30 includes a display 32 having a cursor 34. Pointer 31 includes a puck that is manipulated by the user to control the position of cursor 34 on display 32. The position of puck 33 is monitored by a controller 35 that operates the display.

For certain applications, typically involving large screens, when the user releases puck 11 by removing the user's finger 16, puck 11 is returned to its centered position by the springs shown at 13 that connect the puck to the side 14 of the puck field of motion. Since the user's finger is not applying a vertical force to puck 11 during its return, the change in position associated with that return motion is not reported to the host device. That is, the cursor remains at its previous location. This provides a convenient “re-centering” capability, typically achieved on a mouse by lifting and replacing the mouse at the center of the field of motion. Re-centering is particularly necessary in laptop computers, hand-held devices and other miniature applications in which the puck field of motion is small relative to the cursor field of motion.

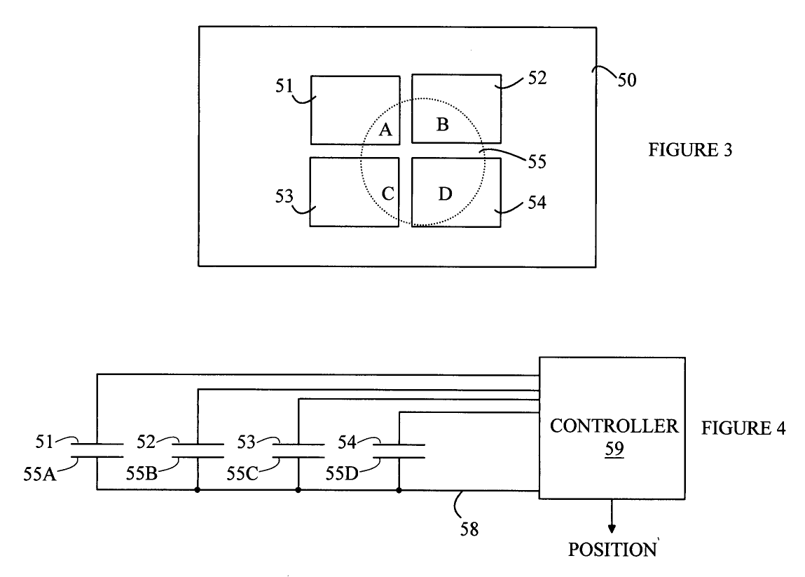

The manner in which the position of the puck is sensed in one embodiment is described in detail in the above-identified patent application, and hence, will not be discussed in detail here. For the purposes of this discussion, it will be assumed that a capacitive sensing scheme can be utilized to determine the puck's position. Such a scheme is illustrated in FIG. 3, which is a top view of a portion of surface 12 shown in FIG. 1 over which the puck moves in one embodiment of the present invention. Surface 50 includes four electrodes shown at 51-54 having terminals that are connected to an external circuit. To simplify the drawing, these terminals have been omitted. The puck has a bottom surface that includes an electrode 55 that is shown in phantom in the drawing. Electrodes 51-55 are electrically isolated from one another. For example, electrode 55 can be covered with a layer of dielectric that provides the required insulation while still allowing electrode 55 to slide over the other electrodes. The electrodes can in fact be patterned on the back of the substrate whose surface is shown at 50. This reduces the capacitance between the electrodes and the puck electrode, but can be practical for substrate thicknesses of a few millimeters or less. The overlap between electrode 55 and each of electrodes 51-54 depends on the position of the puck relative to electrodes 51-54. Denote the overlaps between electrode 55 and electrodes 51-54 by A-D, respectively.

Refer now to FIG. 4, which is a schematic drawing of an equivalent circuit for electrodes 51-55. The portion of electrode 55 that overlaps electrode 51 forms a parallel plate capacitor having a capacitance that is proportional to overlap A. Similarly, the portion of electrode 55 that overlaps electrode 52 forms a parallel plate capacitor that has a capacitance that is proportional to overlap B, and so on. Since all of the capacitors share portions of electrode 55, the equivalent circuit consists of four capacitors connected to a common electrode shown at 58. This electrode is just electrode 55. Hence, by measuring the capacitance between electrode 55 and each of electrodes 51-54, the position of electrode 55 relative to electrodes 51-54 can be determined. This determination can be made by a controller 59, which may be part of the pointing device or part of the host device of which the pointing device forms a part.

For many applications, the spring mechanism and the sensing mechanism should not be exposed to the environment. The area under the puck and springs is difficult to clean. Furthermore, the springs can be damaged by objects that come in contact with the springs from the outside environment. In addition, from an esthetic point of view, a device in which the springs are not visible is often preferred.

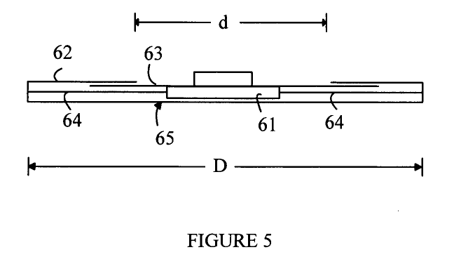

The need to hide the spring and sensing mechanism must be balanced against the need to provide a device that is small and efficient in its use of space. This tradeoff can be more easily understood with reference to FIG. 5, which is a cross-sectional view of puck-based pointing system with a hidden spring and sensing system. Puck 61 moves over surface 65, which includes the sensing electrodes described above. The springs shown at 64 and the sensing system are hidden from view by a shroud 63 that is attached to puck 61 and moves under a overhang 62 such that the view of the underlying mechanism is blocked by the shroud 63. While this mechanism provides some protection against debris entering the cavity containing the springs and sensing mechanism, the protection is limited. For example, the shroud does not prevent liquid from entering the area under the puck. In addition, the distance over which the puck can move, d, is only half of the diameter, D, of the pointing device, since the other half is needed to accommodate the shroud. As noted above, space is at a premium in many applications of interest, such as laptop computers and handheld devices.

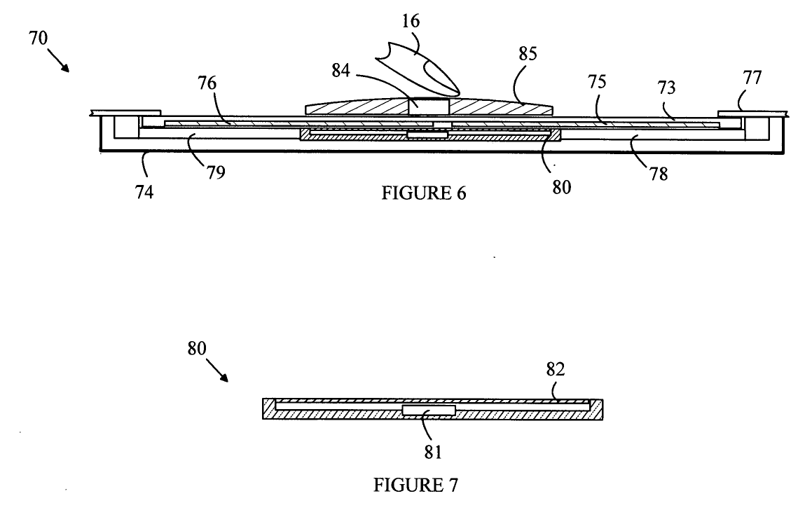

Refer now to FIGS. 6 and 7, which illustrate a pointing device according to one embodiment of the present invention. FIG. 6 is a cross-sectional view through pointing device 70, and FIG. 7 is an enlarged cross-sectional view of bottom puck 80 shown in FIG. 6. Pointing device 70 utilizes two pucks that are magnetically coupled to one another. The user moves top puck 85 on a field of motion defined by the edges of a surface 77 on the host device. Top puck 85 moves over a dielectric stage 73 and is held on the stage by the magnetic force between a magnet 81 in puck 80 and a corresponding magnet 84 in puck 85. The user only sees top puck 85.

Bottom puck 80 includes a magnet 81 and an electrode 82 that moves on the underside of stage 73 over positioning sensing electrodes 75 and 76. Bottom puck 80 moves within a sealed cavity formed by stage 73 and wall 74. Hence, bottom puck 80 and the springs associated with puck 80 are protected from debris and out of sight. The user sees only the top surface of stage 73 and top puck 85.

The position of bottom puck 80 is determined by measuring the capacitance between moving electrode 82 and the sensing electrodes on the bottom of dielectric stage 73 in a manner analogous to that described above with reference to FIGS. 3 and 4. It should be noted that the sensing electrodes on the bottom surface of stage 73 are not shown in the cross-sectional view in FIG. 6.

Bottom puck 80 is connected to springs 78 and 79. These springs serve two functions. First, the springs recenter pucks 80 and 85 when the user 16 releases puck 85. Second, the springs apply an upward pressure on the bottom of puck 80 that keeps that puck in contact with the surface of stage 73 when top puck 85 is removed. It should be noted that this vertical retention function is not needed in embodiments in which the distance between bottom puck 80 and wall 74 is small enough to allow bottom puck 80 to be lifted back into contact with dielectric stage 73 by the magnetic force between the two pucks.

The above-described embodiment utilizes two magnets to couple the top and bottom pucks. However, it should be noted that one of the magnets could be replaced by a piece of ferromagnetic material such as iron.

The embodiment shown in FIGS. 6 and 7 provides the basic position mapping functions discussed above. However, the embodiment shown in these figures does not include a mechanism for sensing the presence of the user 16. That is, there is no mechanism for sensing a force on top of puck 85 that is applied by user 16. For some applications, the presence of the user's finger need not be sensed. The sensing of the user's finger is needed so that the controller can decouple the cursor on the associated display screen from the puck while the puck is being recentered. However, in applications in which the cursor moves on a relatively small screen such as the screen of a cell phone or PDA, the cursor can be directly mapped to the puck position in the field of motion such that there is a one-to-one relationship between the puck position in the field of motion and the cursor position of the device screen. In such small screen applications, the added resolution obtained by being able to recenter the puck without moving the cursor on the screen is often not needed.

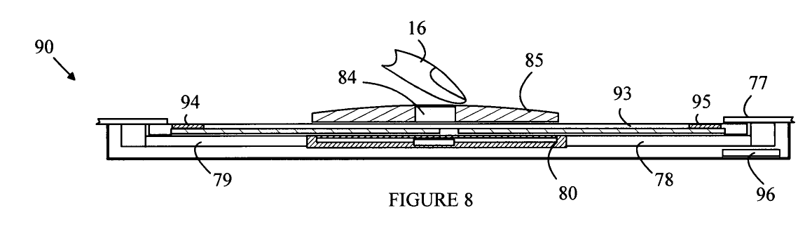

If the pressure exerted by the user 16 on the top puck is to be sensed to provide a means for detecting the user's finger or for generating a mouse “click”, then a mechanism that does not rely on conductors connected to the top mouse is preferred. Refer now to FIG. 8, which is a cross-sectional view of a pointing device 90 according to another embodiment of the present invention. To simplify the following discussion, those elements of pointing device 90 that serve functions analogous to elements discussed above with reference to pointing device 70 have been given the same numeric designation and will not be discussed further here. Pointing device 90 utilizes a flexible stage 93 in place of stage 73 discussed above. Stage 93 includes a number of strain sensors such as strain sensors 94 and 95. The strain sensors measure the strain in stage 93. When the user pushes on top puck 85, the stage is deflected downward and the extent of the deflection is measured by the strain gauges. The extent of the deflection is related to the applied pressure, and hence, can be used by a controller 96 to determine the force with which the user is pushing on puck 85.

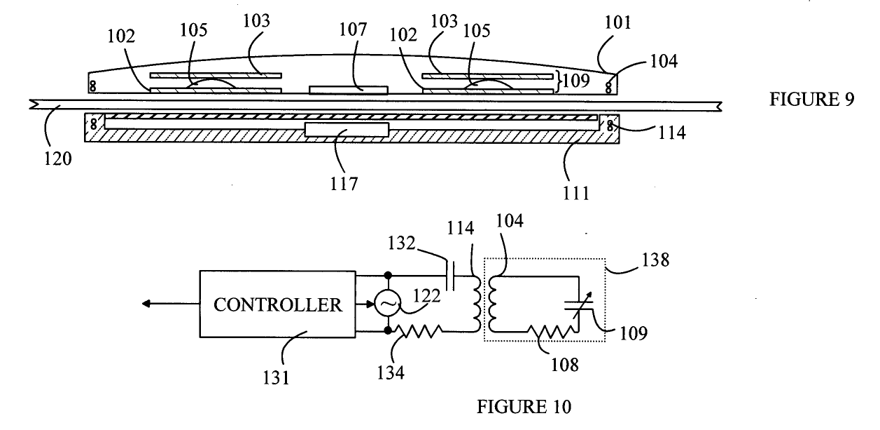

Refer now to FIGS. 9-10, which illustrate a pointing device according to another embodiment of the present invention. FIG. 9 is a cross-sectional view through top puck 101 and bottom puck 111. To simplify the drawing only a portion of stage 120 is shown. Top puck 101 is coupled to bottom puck 111 by magnets 107 and 117, which operate as described above. Top puck 101 also includes a capacitor constructed from two annular electrodes shown at 103 and 102 that are separated by a spring 105. The material from which top puck 101 is constructed is flexible. Hence, when a user applies force to the upper surface of top puck 101, a force is applied to plate 103 of capacitor 109. This force overcomes a portion of the force generated by spring 105 thereby causing the plates to move closer to one another. This decrease in distance results in an increase in the capacitance of capacitor 109. The amount of this increase is a function of the applied force, and hence, the capacitance of capacitor 109 is a measure of the applied force that can be used to sense the presence of a user's finger.

In addition, the capacitance of capacitor 109 can be utilized to implement a “mouse click”. For example, the user can signal a mouse click by pressing on the upper surface of top puck 101 with additional force. It should be noted that spring 105 could be in the form of a “clicker” that suddenly changes shape when sufficient force is applied thereby providing the sensation of a switch closing to the user. This sensation could also include an audible “click”.

The capacitance of capacitor 109 is sensed by utilizing an air transformer constructed from coils 104 and 114. Refer now to FIG. 10, which is a schematic drawing of a circuit that can be used to measure the capacitance of capacitor 109. Capacitor 109 is connected in series with coil 104 to form an LRC tank circuit 138 consisting of coil 104, resistor 108, and capacitor 109. The resistor could be a separate component or merely the resistance inherent in the conductors. A controller 131 applies an AC signal via signal generator 122 to a corresponding tank circuit comprising capacitor 132, resistor 134, and coil 114. By measuring the potential, and/or the current of the signals in this tank circuit, the capacitance of capacitor 109 can be determined and a signal related thereto output. Since the measurement of a capacitance in this manner is known to the art, the details of controller 131 will not be discussed in detail here.

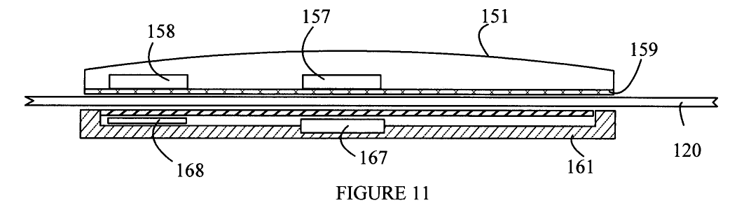

Refer now to FIG. 11, which illustrates a pointing device according to another embodiment of the present invention. FIG. 11 is a cross-sectional view through top puck 151 and bottom puck 161. The two pucks are coupled by magnets 157 and 167 in a manner analogous to that described above. Top puck 151 includes a second magnet 158 and a Hall-effect sensor 168 that measures the magnetic field generated by magnet 158 at the location of the Hall sensor. Top puck 151 also includes a deformable layer 159 whose thickness depends on the force applied to the top surface of top puck 151. When a user applies a force to the top surface of top puck 151, the distance between magnet 158 and Hall sensor 168 decreases. This decrease results in an increase in the magnetic field at Hall sensor 168, and hence, the output of Hall sensor 168 can be used to determine the force being applied to top puck 151.

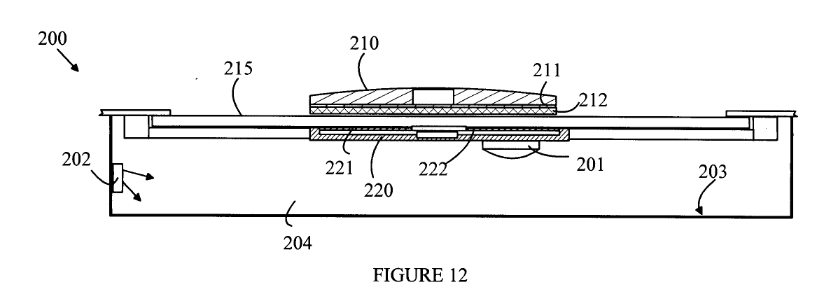

The above-described embodiments of the present invention utilize a capacitative sensing scheme for determining the position of the bottom puck. However, other methods for measuring the bottom puck position can also be utilized without departing from the teachings of the present invention. Refer now to FIG. 12, which illustrates another embodiment of a pointing device according to the present invention. Pointing device 200 includes a top puck 210 that moves on a stage 215 and a bottom puck 220 that are magnetically coupled in a manner analogous to that described above. Bottom puck 220 includes an optical imaging sensor 201 that forms an image of a portion of the surface 203 within cavity 204. Surface 203 is illuminated by light source 202. The image formed by imaging sensor 201 can be used to determine the position of bottom puck 220 in a manner analogous to that used in optical mice. In another embodiment, a map of surface 203 can be stored in the controller, and the position of bottom puck 220 determined by comparing the current image to that map. Since cavity 204 is sealed, problems associated with debris or stray light are minimized.

It should be noted that pointing device 200 does not require position electrodes on the surface of the stage. In such an embodiment, the pressure on top puck 210 can be determined by measuring the distance between top puck 210 and bottom puck 221 using a capacitative measurement scheme. Top puck 210 includes a resilient layer 212 that compresses in response to a vertical force being applied to top puck 210. Top puck 210 also includes an electrode 211 that moves downward when resilient layer 212 is compressed. In this embodiment, bottom puck 220 includes two electrodes 221 and 222 that underlie electrode 211. Electrode 211 capacitatively couples electrodes 221 and 222. The amount of this coupling depends on the vertical distance between electrode 211 and electrode 222. Hence, by measuring the capacitance between electrodes 221 and 222, the force on top puck 210 can be determined.

Various modifications to the present invention will become apparent to those skilled in the art from the foregoing description and accompanying drawings. Accordingly, the present invention is to be limited solely by the scope of the following claims.

What is claimed is:

1. A pointing device comprising:
a stage comprising top and bottom surfaces, said stage having a field of motion defined thereon;
a top puck that moves over said top surface in response to a lateral force being applied thereto, said top puck comprising a first magnetic coupling member;
a bottom puck that moves under said bottom surface, said bottom puck comprising a second magnetic coupling member, said first and second magnetic coupling members acting to cause said bottom puck to move in response to a change in location of said top puck such that said top and bottom pucks remain in a predetermined relative location with respect to one another; and
a position sensor that generates a signal indicative of a location of said bottom puck.

2. The pointing device of claim 1 further comprising a spring system for returning said bottom puck to a predetermined location when said lateral force is not applied to said top puck.

3. The pointing device of claim 1 wherein one of said first and second magnetic coupling members comprises a magnet.

4. The pointing device of claim 3 wherein the other of said first and second magnetic coupling members comprises a magnet.

5. The pointing device of claim 3 wherein the other of said first and second magnetic coupling members comprises a ferromagnetic material.

6. The pointing device of claim 1 wherein said bottom puck is enclosed in a sealed cavity.

7. The pointing device of claim 1 further comprising a pressure signal generator that generates a user present signal if said top puck is subjected to a force greater than a first force level.

8. The pointing device of claim 7 wherein said pressure signal generator generates a button actuated signal if said top puck is subjected to a force greater than a second force level, said second force level being greater than said first force level.

9. The pointing device of claim 8 wherein said pressure signal generator comprises a strain gauge for measuring a deflection in said stage.

10. The pointing device of claim 8 wherein said pressure signal generator comprises a capacitor in said top puck having a capacitance value that depends on said force and a capacitance measuring circuit that measures said capacitance.

11. The pointing device of claim 10 wherein said capacitance measuring circuit comprises a first coil in said top puck and a second coil in said bottom puck, said first and second coils forming a transformer.

12. The pointing device of claim 8 wherein said pressure signal generator comprises an electrode on said top puck; first and second electrodes on said bottom puck; and a circuit for measuring the capacitance between said first and second electrodes.

13. The pointing device of claim 8 wherein said top puck comprises a deformable member that alters the distance between said top puck and said stage in response to said force being applied to said top puck and wherein said pressure signal generator comprises a magnet in said top puck and a sensor in said bottom puck that measures a magnetic field generated by said magnet.

14. The pointing device of claim 1 wherein said position sensor comprises a bottom puck electrode on said bottom puck, a plurality of position electrodes on said stage, and a circuit for measuring a capacitance value between said bottom puck and each of said position electrodes.

15. The pointing device of claim 1 wherein said position sensor comprises a light source and an imaging sensor that moves with said bottom puck.

16. A method for inputting data to a device having a display thereon, said method comprising:
providing a stage having top and bottom surfaces.
providing a top puck that moves over said top surface in response to a lateral force being applied thereto;
coupling said top puck to a bottom puck that moves under said bottom surface;
determining a location for said bottom puck; and
moving a cursor on said display in a manner that depends on said determined location.

17. The method of claim 16 wherein said top and bottom pucks are magnetically coupled.

18. The method of claim 16 further comprising determining a vertical force applied to said top puck in a direction perpendicular to said stage.
